(19) United States
(12) Patent Application Publication
(10) Pub. No.: US 2013/0218361 A1
(43) Pub. Date: Aug. 22, 2013

(54) METHOD OF STORING PERSONALIZED ENERGY

(71) Applicant: Kirkland R. Gable, Thousand Oaks, CA (US)

(72) Inventor: Kirkland R. Gable, Thousand Oaks, CA (US)

(21) Appl. No.: 13/844,967

(22) Filed: Mar. 16, 2013

Related U.S. Application Data
(63) Continuation-in-part of application No. 12/463,327, filed on May 8, 2009.
(60) Provisional application No. 61/051,631, filed on May 8, 2008.

(51) Int. Cl. G06F 1/26

(52) U.S. Cl. CPC G06F 1/26
USPC 700/295

(57) ABSTRACT

An Identifiable Energy Storage Device (IESD) includes a representation of an object and a battery connected to the representation, the device having stored energy collected from the object. The IESD may also include a playback module connected to the device to highlight the representation of the object using energy identified and stored in the device.

### CROSS-REFERENCE TO RELATED APPLICATIONS

This application is a continuation-in-part of pending U.S. application Ser. No. 12/463,327, filed May 8, 2009, which claims the benefit of U.S. Provisional Application No. 61/051,631, filed May 8, 2008. The preceding patents and/or patent applications are hereby incorporated by reference, in their entireties.

### BACKGROUND OF THE INVENTION

1. Field of the Invention

This invention relates to the storage and use of energy. More particularly, the present invention relates to identification of an object of interest, collection of energy from the object of interest and utilization of the identified, collected energy to highlight the object of interest.

2. Description of the Related Art

Energy from a specific energy source can be collected and stored in an Identifiable Energy Storage Device (IESD). The use of IESDs allows people and other entities to select energy from objects that interest them. These objects of interest can be places, events, people, natural habitats and others. For example, a mother in Vermont can select energy from sunsets in Fiji. A coffee import company in New York City can get energy from a coffee field in Costa Rica. Because the energy collected from these sources is identifiable and selectable, it is personalized energy.

When this personalized energy is transferred to users, it can produce considerable social, medical and emotional impact. Consider, for example, the personalized energy created by a Nigerian mother's last speech to her dying child wounded in war. The energy of that last speech can light memorial devices or play videos of the event for people in other countries. Because the users of this energy know the source of it, this energy can heighten the emotional significance. Personalized energy can also come from many other sources, such as motivational speakers, national leaders, healers and celebrations. This energy can be used to reduce stress, promote healing, and facilitate personal wellbeing.

In this era of social unrest, online anonymity, regional wars and nuclear stockpiles, there is an urgent need for positive human communication across the boundaries of political self-interest, economic disparity, ethnicity and religion. The sharing of personalized energy across these boundaries can facilitate opportunities to achieve satisfactory and just resolutions of these problems.

In addition to the benefits noted above, personalized energy allows users to select renewable energy sources such as those described in the parent application, application Ser. No. 12/463,327, filed May 8, 2009, which is incorporated by reference herein, in its entirety, as well as volcanic heat, microbial conversion of biomass, thermal changes in living tissue and blood flow. Energy sources such as these are minimally harmful to the environment. Because personalized energy is scalable, it offers the possibility of substantial benefit.

### SUMMARY OF THE INVENTION

An Identifiable Energy Storage Device (IESD) is disclosed that includes a representation of an object and a battery connected to the representation, the battery having stored energy generated from the object.

In one embodiment of the invention, a method is disclosed that includes identifying an object of interest, collecting energy generated from the object of interest, storing the electrical energy, and capturing a representation of the object of interest.

### BRIEF DESCRIPTION OF THE DRAWINGS

The components in figures are not necessarily to scale emphasis instead being placed upon illustrating the principals of the invention. Like reference numerals designate corresponding parts throughout the different views.

FIG. 1 is a block diagram of an embodiment illustrating a photovoltaic cell connected to a battery to collect energy from an object of interest;

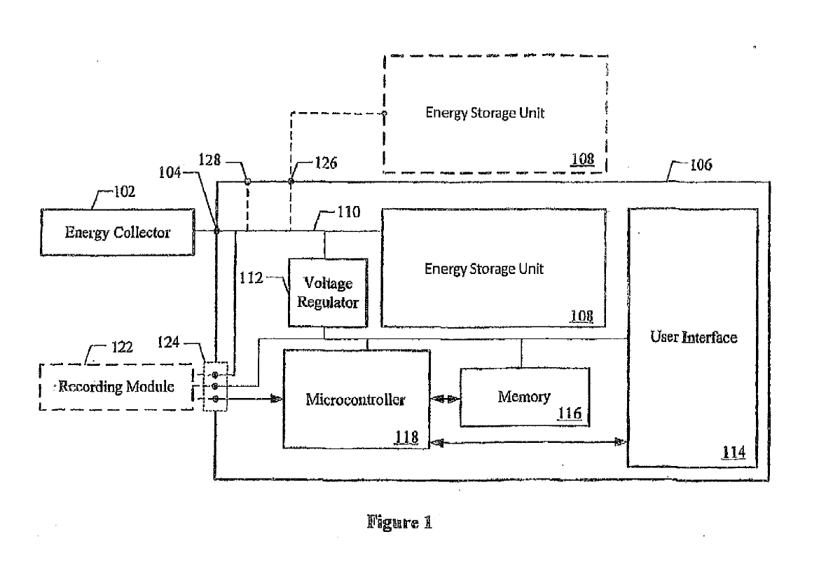

FIG. 2 is a block diagram of an embodiment illustrating an LED light connected to the battery to illuminate a photograph of the object of interest using energy stored in the battery;

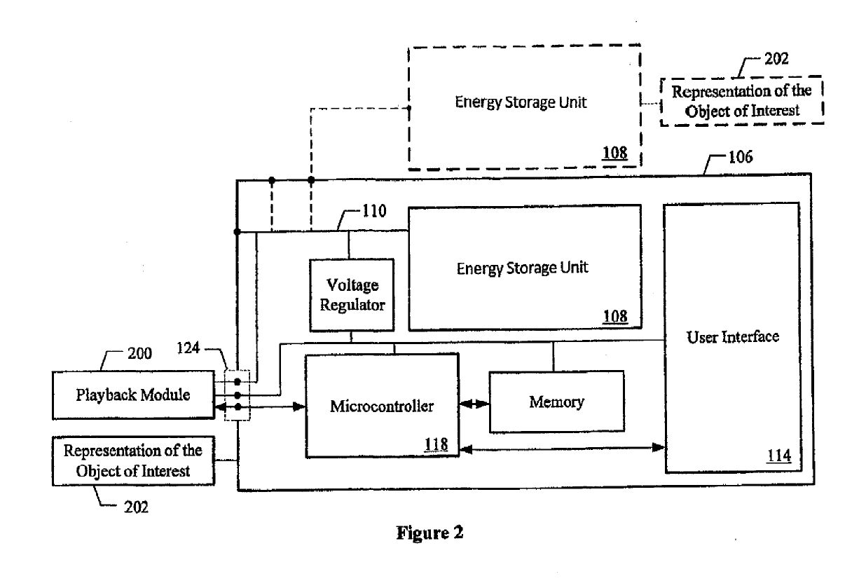

FIG. 3 is a flow diagram of one embodiment that illustrates identifying an object of interest, collecting energy from the object of interest and storing the energy for later use;

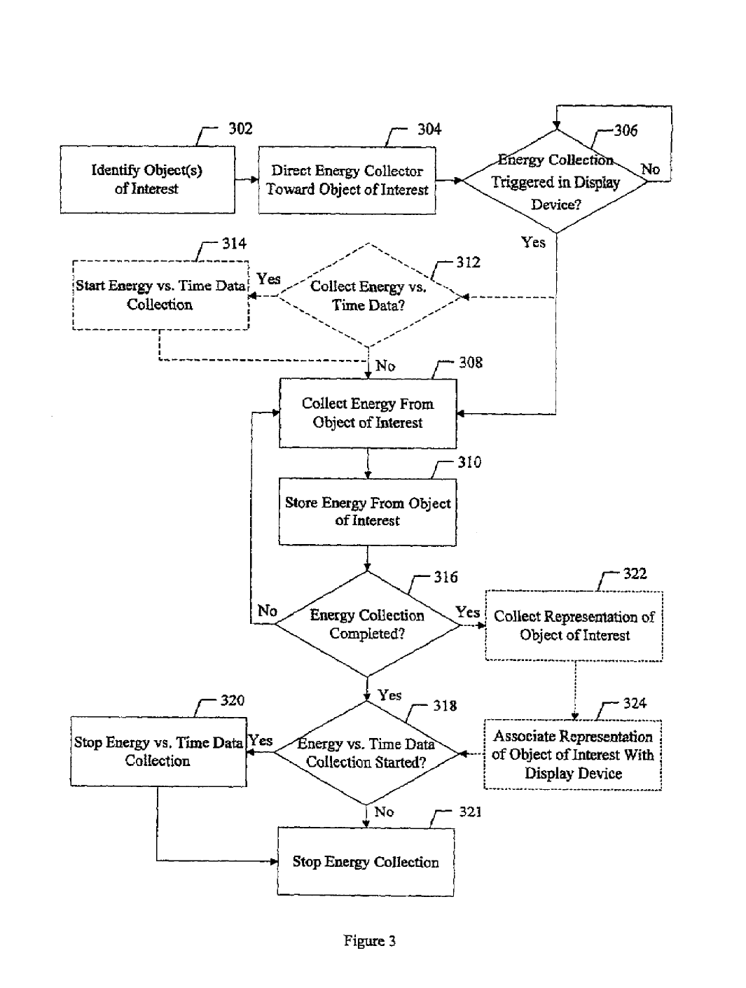

FIG. 4 is a flow diagram of one embodiment that illustrates use of stored energy to illuminate a representation of an object;

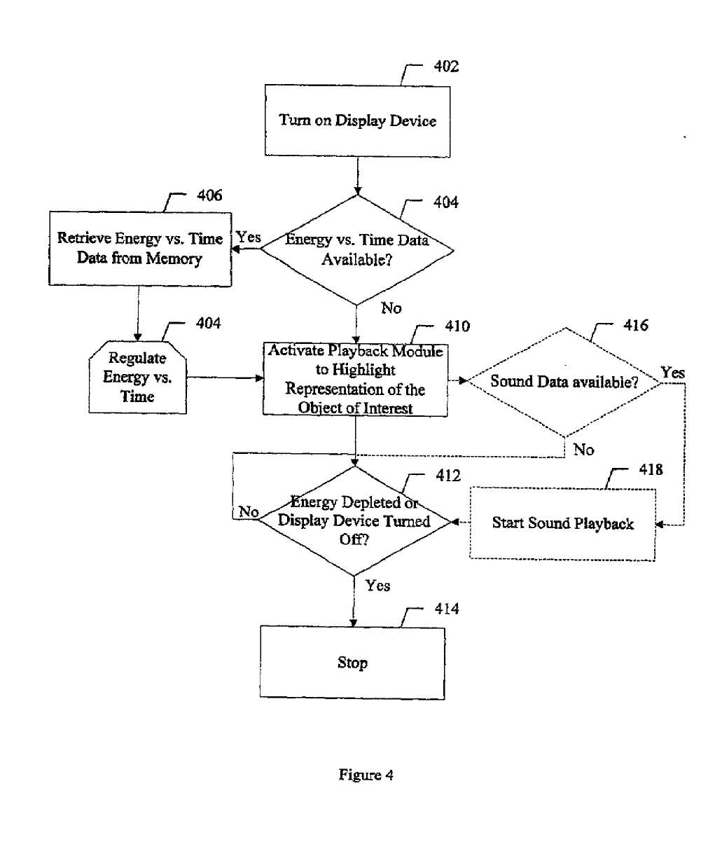

FIG. 5 is a schematic diagram of one embodiment of a visual display unit configured to collect energy produced from an object of interest;

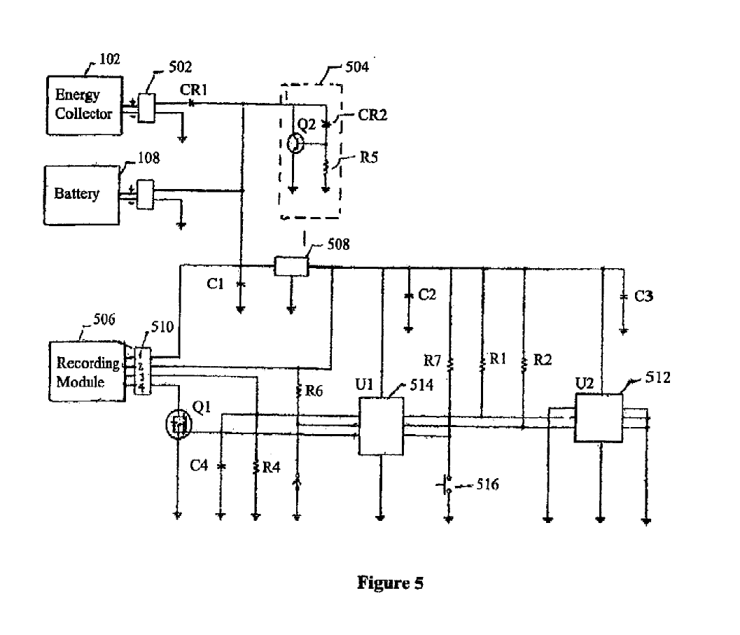

FIG. 6 is one embodiment of a schematic illustrating a visual display unit configured to highlight a representation of an object of interest using illumination from a light source.

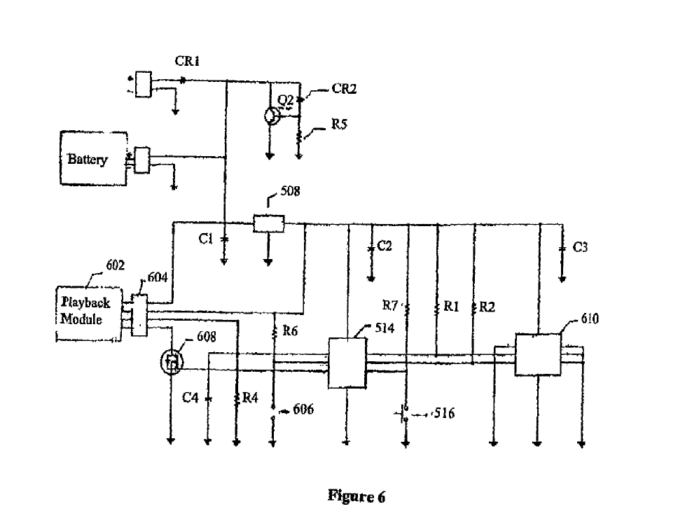

FIG. 7 illustrates one implementation of an IESD used to blend various energies. An energy designer or other person has a palette of energies each represented by the Identified Energy Storage Unit. Although three units are shown, more units may be used. The amount of energy used from each Identified Energy Storage Unit is adjustable.

### DETAILED DESCRIPTION OF THE PREFERRED EMBODIMENTS

### Collection Process

In one embodiment, energy from a specific, identified source of energy such as a landscape or person is stored in an IESD. This same energy can also be stored in energy storage units detachably connected to an IESD. These energy storage units can be common rechargeable batteries as well as micro-supercapacitors, nanocomposite paper, printed batteries and others. (The term “energy storage unit” as used herein refers to the entire range of energy storage media.) The energy stored in these energy storage units comes from sources such as solar, motion/kinetic, piezo, thermoelectric, reflected and electromagnetic induction. For example, a solar energy collector in a landscape is attached to the Energy Collector 102 of the IESD. This energy is stored in the Energy Storage Unit 108. The energy can also be stored in detectably connected energy storage units and standard rechargeable batteries. The energy storage units used to store energy can be those with selected materials and chemistries to optimize performance over long periods of time.

There may be many sources of energy in a single physical setting or single energy collection event, such as a wedding, speech, concert, athletic performance or the filming of a movie. For example, in a family backyard, solar energy can be collected from sunlight. Kinetic energy can be collected from running children and the family dog. Thermoelectric energy can be collected from the BBQ grill. A single IESD with multiple energy collection devices can be used to collect energy from each of these sources. Alternatively, multiple IESDs can be used. Energy collection devices can also be placed on a great variety of inanimate objects of interest that produce energy such as shoes, backpacks, bicycles, cars, lamps and keyboards. In addition, the increasing bioavailability of energy has substantially facilitated the collection of energy and information from living objects such as people and animals.

As the energy is being collected from an energy source, the Recording Module 122 receives data from items related to the production of the selected energy. The data can include information comprising time of collection, quantity of energy collected, variation in the quantity of energy collected, energy duration, characteristics of the surrounding environment and others. The data are collected in real-time and sent to the Microcontroller 118 for storage in the User Interface 114. These data can be collected and recorded in milliseconds, every minute or other various intervals or continuously for intervals up to several weeks. The frequency of this recording depends on the storage capacity of the User Interface 114 and output needs. The information derived from the recorded data is used to develop energy patterns of the energy collected from each energy source. Energy patterns can show variation in the amount of energy collected and many other characteristics. For example, solar energy can be collected during a spring day in Cleveland, Ohio, from 7:00 AM to 12 noon. At seven o'clock, the sky is over-cast with clouds. The recorded information would indicate that relatively little energy was collected. At ten o'clock, there are fast-moving, scattered clouds with the sun flickering through them. The recorded information would indicate rapid alternations in the amount of energy collected. At noon, the sky is clear and the recorded information would indicate a continuous collection of a relatively large amount of energy. The energy pattern for that morning can be represented as a graph with a low, straight, horizontal line near seven o'clock, spikes near ten o'clock and a high, straight, horizontal line near noon. At a later time, the energy collected that morning can be released through the Playback Module 200 as it is being modulated by the energy pattern. Therefore, the energy flows from the Playback Module 200 moment by moment in the same amount as it was collected.

Each event during which energy is collected is unique with regard to its combination of characteristics such as the objects of interest, the time of collection, the surrounding environment, the amount of energy collected and the collected energy patterns. An energy pattern developed during a martial arts exhibition will be much different from the energy pattern developed during a guitar performance. Also, during the energy collection process, representations of the object of interest can be collected, such as videos, DNA samples, soil, signatures, and related items.

In one embodiment, sensors can be placed on or in the bodies of athletes, performers, actors, teams, motivational speakers, animals and other living objects of interest. Biological characteristics can be readily monitored such as heart rate, movement, temperature, glucose levels and brain patterns. These sensors are powered by body energy, IESDs or batteries within, or outside, the sensors.

Output from the User Interface 114 regulates the operation of the sensors. Regulation of the sensors can also be done by on-site personnel or from people in an audience that is either physically present or remotely available. .Information from these sensors is received in real time by the Recording Module 122 and stored in the User Interface 114. The transmission of information from the sensors to the Recording Module 122 and/or a computer or LAN can be done across the surface of the object of interest or by wire, RF, WiFi, Bluetooth, near field communication and other means.

If the object of interest is a person or an animal, it is often possible to classically condition the object to produce specific physiological and psychological responses. These responses can be detected by wearable sensors. A living object's energy and energy patterns can then be collected during conditioned responses such as relaxation, meditation, pleasant emotions, or during a specific set of brain waves. This energy can be augmented by supplemental energy during the conditioned response or later.

Electrodermal activity is among the easily measurable biological characteristics. One aspect of electrodermal activity, among many, is the galvanic skin response (GSR) that measures a person's interaction between an environmental event and the person's psychological state. An increase in the moisture of the skin from sweat glands increases the electrical conductivity of the skin This physiological characteristic combined with the measurement of cardiovascular activity and the movement of facial muscles enables the collection of information about fear, sadness, extroversion, sexual arousal, anger, tension, positive emotion and other emotional states. This information permits the collection of energy and energy patterns at selected times when, for example, when a performer is relaxed or in a very positive emotional state.

Energy can be collected as it passes over or through the surface of a group of objects of interest. In one embodiment, the energy from an energy source flows across the skin of a group of people as they make electrical contact with each other. The first person has a device with the energy source, a circuit to maintain adequate current and an anode that has electrical connection with the person. The last person has electrical connection with a diode connected to a display device such as an LED that is attached to the Energy Collector 102. Energy flows to the Energy Storage Unit 108 and detachably connected energy storage units. Conductivity can be improved with electrode gel. Alternatively, the people can place their hands or other body parts on a conductive material with safely exposed surfaces.

Maple syrup trees in Quebec become moist during warm maple syrup collection times. In one embodiment, the surface of the trees is connected by wire. Current applied to the wire flows through the damp bark of the connected trees. This current is then collected in IESDs and detachably connected energy storage units. The energy storage units and IESDs are then sent to the purchasers of maple syrup to warm the syrup or play a miniature video display while they eat waffles.

Thermoelectric energy can be collected in IESDs and detachably connected energy storage units. In one embodiment, the thermoelectric effect can be used to collect energy from a chef's stove top or from a fireplace during a winter night.

### Design and Transfer Process

The amount of personalized energy collected and stored in the Energy Storage Unit 108 and detachably connected energy storage units can be a trace amount up to the full capacity of the Energy Storage Unit 108 and detachably connected energy storage units. This collected energy can be amplified, blended, enhanced, replicated or transmuted with or without supplemental energy. The necessary supplemental energy can come from personalized energy or from common sources of energy such as commercial batteries and DC current. Land line and Internet connectivity allow the remote operation of IESDs for the design of energy. This connectivity can also facilitate energy and data collection, energy output and the operation of electronically-enabled representations of the object of interest. Energy designers can create IESDs and energy storage units for potential users.

In one embodiment, an energy designer creates personalized energy from a wedding. At the wedding, the designer collects energy from various energy-producing sources. These can be the walking of the bride and groom, the music, and the sound of the wedding ceremony. While the energy is being collected, an energy pattern is also recorded from each of those energy sources. The energy designer regulates the amount of energy that is placed in the Energy Storage Unit 108 and the detachably connected energy storage units from each of the energy sources. For example, out of the total amount of energy that can be placed in the Energy Storage Unit 108, 20 percent is obtained from the entrance of the bride and groom, 50 percent from the music and 30 percent from the ceremony.

The energy collected can be augmented from user-selected energy such as solar, wind, water, or other objects of interest. This blend of energy can be shared with guests during the wedding through wire connected to IESDs, conductive material or other means. Additionally, guests at the wedding can receive electric candles or other energy-activated devices powered by the wedding energy.

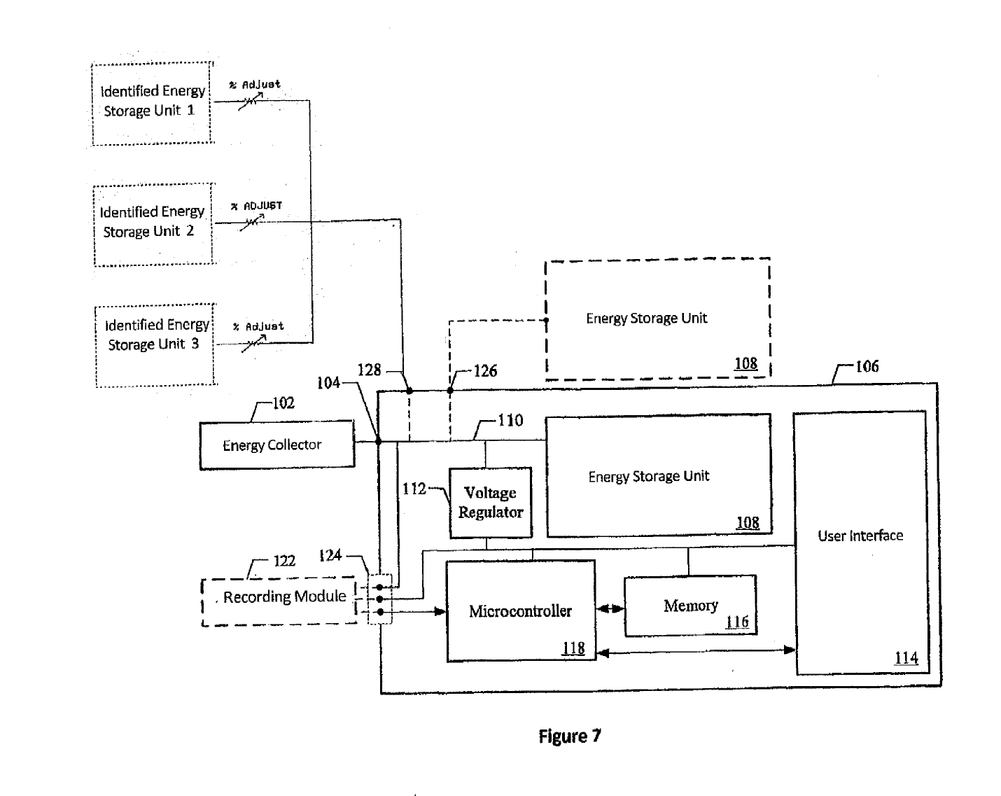

In one embodiment, individual, identified energies are assembled into an energy palette with the various energies displayed, for example, as thumbnails. FIG. 7. With this palette of transferable energies, a designer creates IESDs and energy storage units that have specific proportions of energy from different energy sources. These sources can be either identified or common. For example, energy can be blended to produce hybrid IESDs and hybrid energy storage units that have 35 percent solar energy from a coconut farm in Indonesia, 15 percent heat energy from a sauna in Finland, and 50 percent kinetic energy from the Indy 500. Energy patterns associated with their energy sources are collected and stored and then sent individually or combined to users.

In another embodiment, energy is collected, stored and combined from people and other entities to create community energy. This community energy is subsequently sent to users. For example, a large, central religious organization can collect energy during religious services and subsequently send this identified energy in IESDs or energy storage units to smaller, associated organizations. This community energy can be based upon geographic, social, ethnic, occupational, religious, and other factors.

In one embodiment, energy designers are physically present to collect energy and energy patterns while they record multimedia scenes at spontaneous energy-producing events such as political rallies, sports events, recreational activities, and news events. Energy and energy patterns are also collected from planned multimedia events, such as television shows, lectures, plays, adventure programs, musicals and movies. For example, during the filming of a movie, energy and energy patterns are collected from each actor and stored on a scene-by-scene basis.

Personalized energy storage units can be made available to purchasers in commercial retail markets. They can be designed to include energy from special events, places, people and other objects of interest.

### Output and Use

In one embodiment, the users receive an ISED containing personalized energy, energy patterns and representations of the selected objects of interest in related collection events. When the user presses the appropriate switch of the User Interface 114, it activates the Playback Module 200 and/or the Representation of the Object of Interest 202. This activation can also be done by visual, auditory and other signals that are linked to the IESD by means such as wire, RF, WiFi, Bluetooth and near field communication and other means. Energy patterns stored in the User Interface 114 enable the modulation of personalized energy from the Playback Module 200 to display devices that include an LED, applause recording, conductive material, a tactile display unit and others. For example, a viewer can watch a baseball game on a television powered by the Representation of the Object of Interest 202. When the baseball player runs, personalized energy is modulated through the Playback Module 200 that brightly lights an LED. Less energy is modulated to the LED when the athlete rests.

In another embodiment, energy from an IESM device is linked to a system of audio transducers that enable an enhanced audio experience of personalized energy. When these transducers are properly placed on the body, they produce an experience of inner speech or music that has a deep quality unobtainable with earphones or audio speakers. Various body structures such as the spine, legs, chest, hands, have different resonant frequencies. The portable audio transducers powered by augmented personalized energy are capable of generating frequencies from 8 to 20,000 Hz. that correspond to the resonant frequency of these body structures. Because no ears are needed, this system is usable by people who are deaf or have limited hearing, as well as others.

The users of personalized energy can absorb energy by using transcutaneous energy devices. In one embodiment, a transcutaneous pad contains a small energy storage unit with personalized energy. The pad also contains a switch that toggles the current on and off. As the current passes over the outer skin from anode to cathode, energy is absorbed by the wearer of the pad. During this energy transfer, display devices are operated consisting of an LED and a micropanel voltmeter that indicates the voltage. Transcutaneous energy pads can also include flexible Organic Light-Emitting Diodes and/or other representations of the objects of interest that produced the personalized, absorbable energy contained in the pad. Instead of an energy storage unit within or outside the pad, an IESD can supply the energy to the pad other conductive materials that enable absorption. In an alternative embodiment, a transcutaneous energy device is configured as a small waterproof container with an accessible anode and diode. Users can attach the electrodes to their skin with regular first-aid tape or by other means. The electrodes can be placed on other surfaces or within suitable electrolytes. The amount of current used is selectable.

In one embodiment, each IESD and its detachably connected energy storage units containing personalized energy is made unique by having identification placed on or within the device or unit. Some standard identification means include the use of a signature, a unique number, graphic, fingerprint or code. This identification can be enhanced by engraving, etching or conductive paint. An IC chip can be combined with each IESD and energy storage unit with personalized energy to provide unique identification.

In another embodiment, each IESD and its detachably connected energy storage units containing personalized energy is made unique by having fragments or products of the object of interest attached or embedded so that they can be authenticated by standard DNA identification technologies. Biological products with DNA for identification can be obtained directly from the object of interest or from items in the surrounding environment such as microphones, eating utensils, and clothing. For example, the towels and athletic tape used by a hockey team have DNA suitable for the DNA authentication.

In one embodiment, a representation of the object of interest or other object is included as a portion of an operable circuit. Users can place their fingers on circuits with images constructed from material consisting of conductive ink, conductive adhesive, conductive metals, conductive fabric and other materials. The circuit is then connected to the Playback Module 200. A portion of the circuit can be exposed to allow users to absorb energy when they make contact with it. The operation of the circuit is controlled by the User Interface 114 that operates the Playback Module 200 and the Representation of the Object of Interest 202 or by switches within the circuit. While the circuit is operative, users can watch display devices powered by the Representation of the Object of Interest 202.

In one embodiment, the viewers of movies or other multimedia events can more fully experience them while using display units attached to IESDs. A selection device attached to the IESD allows users to select energy from specific actors and scenes during the movie. The output of energy from the selected actors and scenes to display devices is modulated by energy patterns collected from them while the movie was being filmed. For example, viewers at a movie theater can absorb personalized energy, feel movement and have their olfactory and other senses stimulated by the energy of the actors and scenes they select. The distribution of this personalized energy to the display units of the IESDs of each viewer is done directly by wire to viewers having IESDs. Alternatively, IESD can be powered arm rests with ports into which viewers place their IESDs or by other suitable means.

In another embodiment, portable IESDs contain a movie or other multimedia displays that are powered by the Representation of the Object of Interest 202. The output to the viewer's display units is similar to that described above. These same procedures are also used with suitable energy collection events other than movies.

In another embodiment, motion sensors with RF capability are placed on the object of interest. RF communication from these sensors operates remotely located equipment that moves in a manner coordinated with and replicating the motion of the object of interest. This replicated motion is more or less or equal to the motion of the object of interest. As the RF controlled equipment moves, it generates electric current using the Faraday principle. This energy is transferred by wire to IESDs and detachably connected energy units.

### REFERENCES

25. S. Bray, et al, “Neural coding of reward-prediction error signals during classical conditioning with attractive faces”, Journal of Neurophysiology, vol. 97. No. 4, pp. 3036-3045, 2006.
F. Cristina, et al, “Physiological responses by emotion-eliciting films”, Applied Psychophysiology & Biofeedback, vol. 37, No. 2, pp. 73-79, 2012.
J. C. Gewitz, et al, “Using pavlovian higher-order conditioning paradigms to investigate the neural substrates of emotional learning and memory”, Learning and Memory, vol.7, No. 5, pp. 10257-266, 2000.
G. B. Hmida, et al, “Extracting electric power from human body for supplying neural recording system”, Journal on Smart Sensing and Intelligent Systems, vol. 2, No. 2, pp. 229-245, 2009. I. Morrison, et al, “The skin as a social organ”, Experimental Brain Research, vol. 204, No. 3, pp. 305-314, 2010.

1. A method of storing personalized energy comprising:
selecting an object or event wherein multiple and specific types of energy can be collected from said object or event;
collecting energy obtained from said object or event in an energy collector of an identifiable energy storage device (IESD),
wherein multiple energy collectors in one IESD or multiple IESDs collect said multiple and specific types of energy such that each said specific type of energy is collected in a different energy collector;
accumulating one or more identification data sets relating to said energy collection in a recording module, in real time, for each said specific type of energy, comprising: time of collection, quantity of energy collected, duration of collection time, measurements of variation in strength of energy collected from said object or event at specified time intervals, and environmental characteristics;
capturing, concurrently with said collecting, a representation of said object or event, wherein said representation corresponds to each said specific type of energy;
transferring said identification data from said recording module to a microcontroller, wherein said microcontroller directs said identification data to be stored in a user interface located within said IESD;
transferring said energy from said energy collector to said IESD;
storing said energy in selected energy storage units, wherein said selected energy storage units are contained within said IESD or are detachably connected to said IESD;
converting said identification data set or sets collected from said object or event during an energy collection event into energy patterns, wherein a different energy pattern represents each said specific type of energy;
storing said energy patterns in a user interface in said IESD; and
outputting specific types of energy to a playback module, wherein release of each said specific type of energy is regulated by said energy patterns collected from said object or event during an energy collection event.

2. The method of claim 1 wherein said outputting is coordinated with outputting energy to said representation associated with each said specific type of energy.
